(19) United States
(12) Patent Application Publication
(10) Pub. No.: US 2025/0016237 A1
(43) Pub. Date: Jan. 9, 2025

(54) METHOD AND SYSTEM FOR COMMUNICATING ARTIFICIAL INTELLIGENCE (AI) DATA BETWEEN DEVICES IN A COMPUTING ENVIRONMENT

(71) Applicant: Samsung Electronics Co., Ltd., Suwon-si (KR)

(72) Inventors: Chandrashekhar S Byadgi, Bengaluru (IN); Kartik Anand, Bengaluru (IN); Praveen Naik S, Bengaluru (IN); Ramesh Babu Venkat Dabbiru, Bengaluru (IN); Siva Prasad Gundur, Bengaluru (IN); Prasenjit Chakraborty, Bengaluru (IN); Eric Ho Ching Yip, Suwon-si (KR)

(21) Appl. No.: 18/895,063

(22) Filed: Sep. 24, 2024

Related U.S. Application Data
(63) Continuation of application No. PCT/KR2024/004332, filed on Apr. 3, 2024.

(30) Foreign Application Priority Data
Apr. 14, 2023 (IN) 2023 41027676
Jan. 15, 2024 (IN) 202341027676

(51) Int. Cl. H04L 67/141

(52) U.S. Cl. CPC H04L 67/141

(57) ABSTRACT

An example method for communicating AI data from a sender device to a receiver device in a computing environment may include generating protocol instances of AI data; generating AI metadata description based on AI model information; sending a request comprising the AI metadata description to a receiver device for establishing a session; establishing a session by receiving a response from the receiver device based on the request; sending the AI data associated with the AI metadata description, to the receiver device based on the established session. The receiver device may receive the request and determine the compatibility of the metadata description, generate and send a response, followed by receiving the AI data associated with the AI metadata description.

### CROSS-REFERENCE TO RELATED APPLICATIONS

This application is a continuation of International Application No. PCT/KR2024/004332 designating the United States, filed on Apr. 3, 2024, in the Korean Intellectual Property Receiving Office and claiming priority to Indian Provisional Application No. 202341027676, filed on Apr. 14, 2023, in the Indian Patent Office, and Indian Complete patent application No. 202341027676, filed on Jan. 15, 2024, in the Indian Patent Office, the disclosures of each of which are incorporated by reference herein in their entireties.

### BACKGROUND

### Field

The disclosure relates to a field of data communication and, for example, to a method and a system for managing communication of Artificial Intelligence (AI) data dynamically between devices in a computing environment.

### Description of Related Art

Computing environments serve as an infrastructure to technologies and software platforms that are used to develop, test, deploy, and run applications. As distributed computing, federated learning, and other Artificial Intelligence (AI) communication technologies are growing day by day, streaming of tensor AI data between devices is becoming common. The tensor AI data may include streaming information such as audio and/or video. Currently, senders and receivers prefix a plurality of execution parameters before a session is established for data transmission. However, if at least one of the execution parameters is changed at the sender's side, it is not possible to dynamically negotiate with the receiver. The execution parameters may, for example, be related to signalling parameters or header transmission parameters of the tensor AI data. For example, if information related to the signalling parameters changes, it is not possible to dynamically re-negotiate tensor AI metadata information. For instance, if specific compression or encoder techniques are used during the data session of the AI tensor data, the receiver requires to hardcode the same techniques. Furthermore, if the sender changes the encoding or the compression techniques and if the receiver is not aware of the changes, then is not possible to further continue the data session. Hence, the on-going session is stopped and re-started with a new set of execution parameters which are manually hard coded at the sender and receiver's side.

Further, for streaming applications associated with the tensor AI data, it is difficult to track tensor data packets when information related to the header transmission parameters changes, as each tensor data is huge in size and it cannot be traced easily between sender and receiver. In order to manage the header transmission parameters of the tensor AI data, headers are required so that each tensor stream can be associated with one particular AI activity in a device. For instance, if a developer traces changes with respect to the header transmission parameters, such as a stream identifier, then the flow of the tensor AI data from the respective stream identifier is required to be traced.

Currently, tensor AI data may be transmitted using transport protocols. This leads to complexity during the data transmission, which multi-folds if multiple data sessions are involved. Further, the tensor packet sequences that are received at the receiver side may need to be manually counted. Since the data transmission relates to a stream of tensor AI data, it is difficult to efficiently identify the tensor packet sequences, as it is not always within a scope of the developer.

Therefore, existing approaches of AI data communication have limitations related to manual handling of the execution parameters which are becoming tedious and complex as AI applications grow in the device. As there is no defined mechanism to carry out the streaming of the tensor AI data, it is becoming increasingly difficult to manage multiple data sessions.

The information disclosed in this background of the disclosure section is only for enhancement of understanding of the general background of the disclosure and should not be taken as an acknowledgement or any form of suggestion that this information forms prior art already known to a person skilled in the art.

### SUMMARY

According to example embodiments, one or more shortcomings of the prior art may be overcome, and additional advantages may be provided through the present disclosure. Additional features and advantages may be realized through the techniques of the present disclosure. Other embodiments and aspects of the disclosure are described in detail herein and are considered a part of the disclosure.

In an example embodiment, a method of communicating AI (Artificial Intelligence) data from an electronic apparatus to an external electronic apparatus may include generating one or more protocol instances associated with the AI data for an application executed on the electronic apparatus, generating AI metadata description for the AI data based on AI model information, wherein the AI metadata description includes at least the one or more protocol instances and at least one or more predefined parameters, sending a request including the AI metadata description to the external electronic apparatus for establishing a session between the electronic apparatus and the external electronic apparatus, establishing the session between the electronic apparatus and the external electronic apparatus based on a response being received from the external electronic apparatus according to the request, and sending the AI data associated with the AI metadata description, to the external electronic apparatus based on the established session.

In an example embodiment, the one or more protocol instances may include at least one of an AI type, a content type, a response data type, a transport protocol, or a predefined range of AI model layers executed by an AI model associated with the application.

In an example embodiment, the one or more predefined parameters may include at least one of AI (Tensor) dimension, AI shape, AI quantized, AI framework, AI model, AI codec, AI compression, or AI response port.

In an example embodiment, the method may include dynamically generating an updated AI metadata description during an on-going data session, on detecting changes in the AI data associated with the on-going data session, wherein the updated AI metadata description is generated based on updated AI model information, sending an updated request including the updated AI metadata description to the external apparatus, wherein the updated AI metadata description includes at least one or more updated protocol instance and at least one or more updated predefined parameters, receiving an updated response from the external apparatus based on the corresponding updated AI metadata description, wherein the updated response includes at least one negotiated parameter for the updated AI metadata description, and sending the AI data associated with the updated AI metadata description, to the external apparatus based on the updated response.

In an example embodiment, the change may be detected by the electronic apparatus based on at least one of one or more variations in network conditions associated with the electronic apparatus and availability of the external apparatus or one or more computing resources associated with the AI data.

In an example embodiment, the response may include at least one negotiated parameter for the AI metadata description, based on capabilities associated with the external electronic apparatus.

In an example embodiment, the at least one negotiated parameter may be indicative of at least compatible parameters and at least incompatible parameters, from the one or more protocol instances and the one or more predefined parameters.

In an example embodiment, the at least one negotiated parameter may be transmitted based on predefined session protocols.

In an example embodiment, the establishing of the session may include assigning at least one unique header parameter including stream identifier, sequence number, timestamp, AI data payload, size of AI data and AI data processor, for the electronic apparatus to communicate the AI data.

In an example embodiment, the at least one unique header parameter may be used for sending the AI data associated with the application, to an external electronic apparatus.

In an example embodiment, the AI metadata description and the AI data may be negotiated and transmitted, respectively, between the electronic apparatus and the external electronic apparatus using AI header parameters.

In an example embodiment, an electronic apparatus for communicating AI (Artificial Intelligence) data from an electronic apparatus to an external electronic apparatus may include at least one processor, and memory communicatively coupled to the at least one processor, wherein the memory stores instructions, which, on execution by the at least one processor, cause the electronic apparatus to generate one or more protocol instances associated with the AI data for an application executed on the electronic apparatus, generate AI metadata description for the AI data based on AI model information, wherein the AI metadata description may include at least the one or more protocol instances and at least one or more predefined parameters, send a request including the AI metadata description to the external apparatus for establishing a session between the electronic apparatus and the external electronic apparatus, establish the session between the electronic apparatus and the external electronic apparatus based on a response being received from the external electronic apparatus according to the request, and send the AI data associated with the AI metadata description, to the external electronic apparatus based on the established session.

In an example embodiment, the one or more protocol instances may include at least one of an AI type, a content type, a response data type, a transport protocol, or a predefined range of AI model layers executed by an AI model associated with the application.

In an example embodiment, the one or more predefined parameters may include at least one of AI (Tensor) dimension, AI shape, AI quantized, AI framework, AI model, AI codec, AI compression, or AI response port.

In an example embodiment, the processor may be further caused to dynamically generate an updated AI metadata description during an on-going data session, on detecting changes in the AI data associated with the on-going data session, wherein the updated AI metadata description may be generated based on updated AI model information, send an updated request including the updated AI metadata description to the external electronic apparatus, wherein the updated AI metadata description may include at least one or more updated protocol instance and at least one or more updated predefined parameters, receive an updated response from the external electronic apparatus based on the corresponding updated AI metadata description, wherein the updated response may include at least one negotiated parameter for the updated AI metadata description, and send the AI data associated with the updated AI metadata description, to the external electronic apparatus based on the updated response.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate non-limiting example embodiments and, together with the description, serve to explain the disclosed principles. In the figures, the left-most digit(s) of a reference number identifies the figure in which the reference number first appears. The same numbers are used throughout the figures to reference like features and components. The above and other aspects, features and advantages of certain embodiments of the present disclosure will be more apparent from the following detailed description, taken in conjunction with the accompanying drawings, in which:

FIG. 1 shows an example embodiment for communicating Artificial Intelligence (AI) data between a sender device and a receiver device in a computing environment, in accordance with various embodiments of the present disclosure;

FIG. 2 shows an example embodiment of communication of AI data between devices in a distributed computing environment, in accordance with various embodiments of the present disclosure;

FIG. 3 shows an example embodiment of communication of AI data between devices in a federated learning environment, in accordance with various embodiments of the present disclosure;

FIG. 4 shows an example embodiment of communication of AI data dynamically between devices in a split federated learning environment, in accordance with various embodiments of the present disclosure;

FIG. 5 shows an example embodiment of negotiation of AI metadata description between sender device and receiver device, in accordance with various embodiments of the present disclosure;

FIG. 6 shows an example embodiment of transmission of AI data between sender device and receiver device, in accordance with various embodiments of the present disclosure;

FIG. 7 shows an example embodiment of re-negotiation of AI metadata description between sender device and receiver device, in accordance with various embodiments of the present disclosure;

FIGS. 8A, 8B, 8C, 8D, 8E, 8F, 8G, 8H, and 8I show example byte representations of AI metadate headers transmitted between sender device and receiver device in accordance with various embodiments of the present disclosure;

FIG. 9 shows a detailed block diagram of an example sender device, in accordance with various embodiments of the present disclosure;

FIG. 10 shows a detailed block diagram of an example receiver device, in accordance with various embodiments of the present disclosure;

FIG. 11 shows a flowchart illustrating an example method of communicating AI data from a sender device to a receiver device in a computing environment, in accordance with various embodiments of the present disclosure;

FIG. 12 shows a flowchart illustrating an example method of communicating AI data from a receiver device to a sender device in a computing environment, in accordance with various embodiments of the present disclosure;

FIG. 13 shows a block diagram of an example system for implementing embodiments in accordance with various embodiments of the present disclosure; and

FIG. 14 shows a block diagram of an example system for implementing various example embodiments consistent with the present disclosure.

It should be appreciated art that any block diagrams herein represent conceptual views of illustrative systems embodying the principles of the present disclosure. Similarly, it will be appreciated that any flow charts, flow diagrams, state transition diagrams, pseudo code, and the like represent various processes which may be substantially represented in a non-transitory computer readable medium and executed by a computer or processor, whether or not such computer or processor is explicitly shown.

### DETAILED DESCRIPTION

In the present document, the word “example” is used herein, for example, to mean “serving as an example, instance, or illustration.” Any embodiment or implementation of the present subject matter described herein as an “example” is not necessarily to be construed as preferred or advantageous over other embodiments.

While the disclosure is susceptible to various modifications and alternative forms, specific example embodiments thereof are shown by way of example in the drawings and will be described in detail below. It should be understood, however, that it is not intended to limit the disclosure to the forms disclosed, but on the contrary, the disclosure is to cover all modifications, equivalents, and alternatives falling within the scope of the disclosure.

The terms “comprises,” “comprising,” “includes” or any other variations thereof, are intended to cover a non-exclusive inclusion, such that a setup, device, or method that includes a list of components or steps does not include only those components or steps but may include other components or steps not expressly listed or inherent to such setup or device or method. In other words, one or more elements in a system or apparatus proceeded by “comprises . . . a” or “includes . . . a” does not, without more constraints, preclude the existence of other elements or additional elements in the system or method.

Disclosed herein are example methods, an example sender device, and an example receiver device for managing communication of Artificial Intelligence (AI) data dynamically in a computing environment. In existing techniques, the AI data may be communicated between devices based on transport protocols which leads to complexity during data transmission as multiple data transmission sessions are involved. Further, in order to manage the communication, developers are required to manually keep track of changes that are associated with execution parameters, which occur during the data transmission sessions. In some instances, the occurred changes may not always be within the scope of the developer. Hence, the existing techniques have limitations related to manual handling of the execution parameters which are becoming tedious and complex with growth of AI applications in the device.

Therefore, in view of the above, the present disclosure discloses various example methods of managing communication of Artificial Intelligence (AI) data dynamically between devices in a computing environment. The present disclosure can facilitate management of the multiple data transmission sessions between multiple devices, based on an agreed communication format which is associated with execution environments of the sender device and the receiver device for different computing scenarios. Thus, the present disclosure can provide methods specific to AI data streaming which can save numerous unwanted and out-of-domain activities such as connection management, dynamic negotiation, dynamic encoding support, and the like. Further, the present disclosure can improve inference latency by negotiating advanced AI codecs during negotiation, which reduces redundant AI data being transferred over a network.

In the following detailed description of example embodiments of the disclosure, reference is made to the accompanying drawings that form a part hereof, and in which are shown by way of illustration specific embodiments in which the disclosure may be practiced. These example embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

The present disclosure relates, in general, to neural networks and, for example, to a method and a system for tensor data protocol for artificial intelligence data communication.

In recent times, distributed computing is gaining vast attention from researchers and developers where computation can be done on multiple devices. As execution is distributed over devices, Artificial Intelligence (AI) application developers have to predefine or hardcode the send/receive format of AI data. As AI applications handle more scenarios such as distributed computing, federated learning, split federated learning etc., it becomes more complicated to manage these tasks. For example, in a split computing environment, machine learning model execution is distributed among two or more computationally capable devices. In a typical scenario, some part of the execution happens on one device and the rest on another.

There is no agreed communication format between the devices on execution environment of tensor data for different scenarios. For example, split execution sends a partial inference data from one device to another device. In a case of federated learning, a client executes a model locally and sends only the weights and biases to a federated server and the federated server sends updated weights to clients In split federated learning, a client runs a sub model and sends tensor data to a split federated server and the split federated server sends back propagation data (loss and gradient) to the client. In the future, AI streams will continue to grow between devices (e.g., SWARM intelligence, MAS AI, etc.).

In some scenarios, a sending device executes CNN layers from 1 to K out of N layers, and sends to another device to run the K+1 to N layers. Further, the receiving device may be unable to find the details under which the sending device executed the model. Along with the Kth layer data, sending device may have shared some details about the “tensor data”.

For instance, the shared details may include:
The number of layers executed by the sending device, so that the receiving device can start to execute from remaining layers.
The quantization details of the model being used by the sending device.
The shape of an intermediate layer output.
The AI related data, such as whether it is forward propagation, partial inference, weights, and biases.
   In case of streamed AI data, the details to track the number of streams being sent and received.

In an example embodiment, a method and a system for communicating tensor data from one apparatus to another apparatus may be provided. Accordingly, the disclosure describes a dedicated session (Tensor Metadata Description) specific to tensor data to be exchanged between devices. Thus, the disclosure discloses, for example, characteristics (tensor parameters) which can be dynamically exchanged either as a part of session negotiation or during an ongoing data transmission between sender and receiver. When a session is established using tensor data protocol, a tensor streaming session is established between sender and receiver.

In an example embodiment, a non-limiting method, and a system for communicating tensor data from one apparatus to another apparatus may be provided. Accordingly, the disclosure describes, for example, establishing a data session between two electronic apparatuses in a distributed computing environment by dynamically exchanging characteristics using a tensor header parameter. Embodiments of the disclosure can be used to communicate any AI tensor data between a sender and a receiver.

In an embodiment, a method and system is provided wherein, defining a tensor data protocol, which is an application layer protocol, includes Tensor Metadata Description (tensor signalling) and Tensor data: Tensor header, Tensor data processor, Tensor codec (tensor data encoder/decoder), tensor data payload blocks.

In recent times, distributed computing is gaining vast attention from researchers and developers where computation can be done on multiple devices, as execution is distributed over devices, Artificial Intelligence (AI) application developers have to predefine or hardcode the send/receive format of AI data. As AI applications handle more scenarios such as distributed computing, federated learning, split federated learning etc., it becomes complicated to manage these tasks. For example, in a split computing environment, machine learning model execution is distributed among two or more computationally capable devices. In a typical scenario, some part of the execution happens on one device and the rest on another.

Further, there is no agreed communication format between apparatuses on an execution environment of tensor data for different scenarios. For example, a receiving device may not have any information regarding the number of layers to execute, the kind of data to process, the type of model to use, the dimension of data, etc.

In an embodiment, a procedural flow (regarding tensor data) for a first use case for split computing/distributed computing networks includes the sending device executing CNN layers from 1 to K out of N layers and sending execution environment and tensor data using the tensor data protocol to another device to run K+1 to N layers. The receiving device reads tensor data headers to identify the tensor data, such as dimension of a tensor data, CNN layers executed at sending device, quantized data or float data, quantization type, differential encoded data or not, etc. Upon loading the appropriate model which matches to tensor data headers the receiving device executes from K+1 layers to N layers of a CNN model.

In an embodiment, a block representation of tensor data protocol and tensor metadata description may include, for example, a tensor data protocol parameter including a plurality of parameters such as header field, tensor data field, tensor processor, tensor model, etc.

In an embodiment, a block representation of tensor data protocol as an application protocol for data communication between sender and receiver may be provided. The tensor data protocol includes, for example, protocol headers, tensor codec (encoder/decoder), optimized methods specific to tensor data like simultaneous encoding and sending/simultaneous receiving and decoding.

In an embodiment, a flow representation of tensor data protocol as an application protocol for data communication between sender and receiver may be provided. In the case of distributed computing, at a sending side, a partial inference model is executed at the sender and tensor data is transferred to the receiver (cloud, edge cloud, server, device etc.) using a tensor data protocol. A tensor metadata description has been set before sending the tensor data.

In an embodiment, at the receiver side, a tensor data protocol instance is created in receiver mode (subscribed to receive a tensor data by listening on some standard port to receive tensor requests) waiting for tensor requests, and tensor metadata description is received and read and prior receiving tensor data. Upon receiving a request, a receiver apparatus reads tensor headers.

In an embodiment, representations of procedural flow of sequence which exchange tensor specific information (signaling and response) may be provided. Further, the process of tensor signalling is disclosed. The tensor signalling can be implemented using any generic protocol like JSON, XML, text parsing or protocols like SDP, SIP, or any other signalling protocols. Any transport protocol can be used to send this negotiation information.

The terminologies may include the following:
Sender wants to send “FLOAT” tensor data
Sender wants to send 3D FLOAT tensor data with shape [3] [4] [5]
Content type: Partial Inference (PI)/Forward Propagation (FP)/Back Propagation (BP)/Full Inference (FI)
Data Type: Differential codec used (DIFF) or not (FULL)
TensorCodec: Codecs designed especially for tensor data, or any other efficient codec used for tensor data reduction.
Transport Protocol supported to send the tensor data. Port to contact the Sender
Tensor Compression: Tensor compressions supported by sender (Brotli, z-standard, DEFLATE etc.).

The process of Tensor Signalling response may be include:
Tensor data receiver listening on a predefined standard port (Like HTTP port 80, MQTT port 1883 etc.,)
Accepts the signalling request and reply to the signalling parameters.
Receiver refers CNN model on which “ContentType” action is required
Sender picks the protocol; port mentioned in signalling and connect to Receiver and starts sending the tensor data.
Receiver picks the tensor data and refer to signalling parameters. And invoke an appropriate action based on content type

In an embodiment, a representation split computing/distributed computing using a session based negotiation according to various embodiments may be provided. The sending device executes k layers and sends the partial inference data over network to AI service modules present in cloud/edge.

In an embodiment, a representation of procedural tensor specific information flow using control message in distributed computing may be provided. The sending device sends Tensor Metadata Description to the receiver, upon which the receiver generates the answer for a partial inference content type.

In an embodiment, a representation of tensor headers during procedural tensor specific information flow using control message in distributed computing may be provided. The tensor specific information may include various fields such as tensor header, payload length, and payload. Accordingly, the AI modules being loaded with reference to the “ContentType”.

In an embodiment, a representation of procedural flow of sequence in federated learning which exchange tensor specific information (signaling and response) may be provided. Multiple decentralized edge devices or servers holding local data samples, are trained without exchanging the training algorithm.

In an embodiment, a representation of procedural tensor specific information flow (signaling and response) using control message in federated learning may be provided. In a case of federated learning as well as client updating to a federated server, at a sending side, a partial inference model is executed at the sender and tensor data is transferred as well to a receiver (cloud, edge cloud, server, device etc.) using a tensor data protocol. A tensor metadata description has been set before sending the tensor data.

In an embodiment, at a receiver side, a tensor data protocol instance created in receiver mode (subscribed to receive a tensor data listening on some standard port to receive tensor requests) and waiting for tensor requests, a tensor metadata description is received and read and prior receiving tensor data. Upon receiving a request, the receiver apparatus reads tensor headers.

In an embodiment, a representation of tensor headers during procedural tensor specific information flow using control message in federated learning may be provided. The tensor specific information may include various fields such as tensor header, payload length, and payload. Accordingly, the AI modules being loaded with reference to the “ContentType”.

In an embodiment, a representation of procedural tensor specific information flow (signaling and response) using control message in split federated learning may be provided. This illustrates a backbone propagation model in a case of split federated learning, wherein the back propagation data would be transferred back to the clients.

In an embodiment, a representation of procedural tensor specific information flow (signaling and response) using control message in split federated learning may be provided.

In an embodiment, a representation of tensor headers during procedural tensor specific information flow using control message in split federated learning may be provided.

In an embodiment, a representation of procedural error flow may be provided. In this scenario, where the tensor receiver could not handle the request, it would identify the appropriate error as follows:
400: bad request
403: Forbidden
404: Not found
408 Request time out
500: Internal server error
501 Not implemented
503 Service unavailable, etc.

In an embodiment, a representation of tensor data protocol for dynamic enabling/disabling of tensor codec feature in distributed computing network may be provided. If the encoder which is in progress does not give good results, then the protocol automatically turns off the AI data codecs.

In an embodiment, a representation of tensor data protocol for dynamically re-negotiating a tensor parameter in data communication network may be provided. In this scenario, the sender changes the tensor signaling during tensor data, which is in progress, then the tensor metadata description is renegotiated again.

In an embodiment, a representation of tensor data header may be provided. The tensor data may include the following fields:

Header fields: Headers are required during initial setup of a tensor session. If this bit is set to 1, the packet contains a header parameter and payload, if this bit is set to 0, the packet contains only tensor payload.

In between sessions, if any tensor environment changed (e.g., layers executed at client), this field is set to 01, receiver should read updated header and prepare the execution environment according to the tensor headers.

Output content: These fields indicate, final inference data type it can receive from the device 2.

Dimension: Dimension of a tensor data, so that receiving side can convert the data to appropriate dimension.

Content type—It tells the tensor data present in protocol is of what type.

In case of split computing, data content could be “partial inference”. In AI use cases, model file can be shared between devices, in this case data content could be “Model file data”. In case of federated learning, data content could be “weights” of a local model sent to update the global model. This can be initiated from the cloud to update the global trained model's “weights” to local model. In case of split federated learning, data content could be “back propagation” model to adjust the weights of local model. Any kind of tensor content can be specified using “tensor-content header.

There needs a mechanism to find a common capability of devices which are specific to tensor data for efficient data communication. Like common tensor codec, avoids lot of unnecessary data being transferred over network.

Universal protocol to communicate all kind of AI/ML tensor data between devices.

Standardising the protocol helps unified communication of AI data irrespective of the vendor solutions.

Single applications can create many instances of tensor and use them for different AI activities.

Tensor data protocol is programming languages agnostic.

Tensor data protocol is platform agnostic Ex: device-1 could be in android and device-2 could be in Linux

All AI services (Wherever services present cloud, edge etc.,) can be accessible using tensor data protocol, clients who are complaint to tensor data protocol can leverage.

Timestamp for tensor data helps in calculating RTT, packet drops congestions etc., depending on this info tensor applications can take appropriate action.

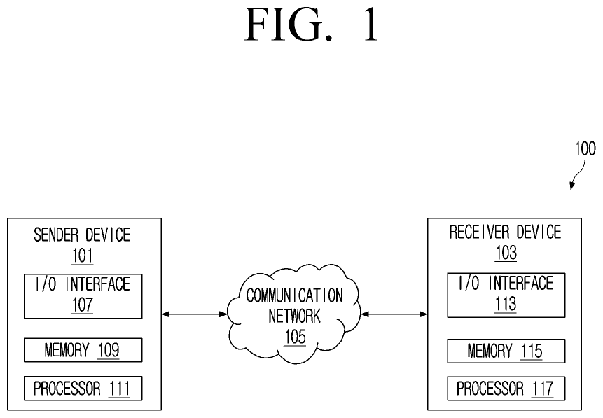

FIG. 1 shows an example embodiment for communicating Artificial Intelligence (AI) data between a sender device and a receiver device in a computing environment, in accordance with various embodiments of the present disclosure.

FIG. 1 shows an environment 100 for communicating Artificial Intelligence (AI) data between a sender device and a receiver device in a computing environment. As shown, the environment 100 includes a sender device 101, a receiver device 103, and a communication network 105. In an example embodiment, the environment 100 may include one or more sender devices and one or more receiver devices. The sender device 101 includes an I/O interface 107, memory 109, and a processor 111. Similarly, the receiver device 103 may include an I/O interface 113, memory 115, and a processor 117. In an example embodiment, the sender device 101 and the receiver device 103 may host and execute one or more AI applications and AI activities based on the computing environments. In an example embodiment, the computing environments may include, but not limited to, a distributed AI data computing environment, a federated learning environment, a split-federated learning environment, a Multi-Agent-System (MAS) AI environment, Swarm Intelligence (SI) environments, and the like.

When one or more applications are hosted on the sender device 101, AI metadata description is generated by the sender device 101 by generating one or more protocol instances associated with the one or more applications. In an embodiment, the AI metadata description may correspond to tensor metadata associated with the one or more applications. In an embodiment, the one or more applications may correspond to AI applications, which may include, but are not limited to, data streaming applications, AI navigation applications, applications associated with predictive analysis, AI based assistants, and the like. In an example embodiment, the one or more protocol instances may include at least one of an AI type, a content type, a response data type, a transport protocol, or a predefined range of AI model layers executed by an AI model associated with the application. For example, the sender device 101 obtains input data associated with each of the one or more applications and executes the AI model associated with the sender device 101 based on the input data. The input data includes the one or more protocol instances generated by the sender device 101 and the sender device performs execution of the AI model on each of the one or more protocol instances to generate an output. The generated output includes AI data which is associated with each of the one or more applications. In an example embodiment, the AI data may include, but is not limited to, partial inference data, weights and biases, data associated with forward and backward propagation, and the like.

Upon generation of the one or more protocol instances, the sender device 101 generates the AI metadata description for the AI data based on AI model information. The AI model information may correspond to details associated with the application on the sender device 101. In an example embodiment, the AI model information may include, but is not limited to, AI model type, number of layers to be executed in the AI model, split point associated with the AI data, and the like. The AI metadata description includes the previously generated one or more protocol instances and one or more predefined parameters. The one or more predefined parameters include at least one of AI (Tensor) dimension, AI shape, AI quantized, AI framework, AI model, AI codec, AI compression, or AI response port.

Then, the sender device 101 initiates a session negotiation with the receiver device 103 by transmitting a request including the AI metadata description to the receiver device 103. The session negotiation is initiated prior to establishing a data transmission session for dynamically managing the communication of the AI data. For example, the one or more protocol instances and the one or more predefined parameters which are sent in the request may correspond to the AI data type “float” format, the shape of “3D”, and AI data with dimensions as “3, 4 and 5”. Further, the sender device 101 may execute “10” layers of the AI model which is “not quantized”, and a Convolutional Neural Network (CNN) framework used for the execution corresponds to “XYZ”. Furthermore, the sender device 101 may use port “12345” to receive an output of the AI data with the type of the AI data corresponding to “inference data”. The output of the AI data is received using the transport protocol as “Web Real-Time Communications (WebRTC)”.

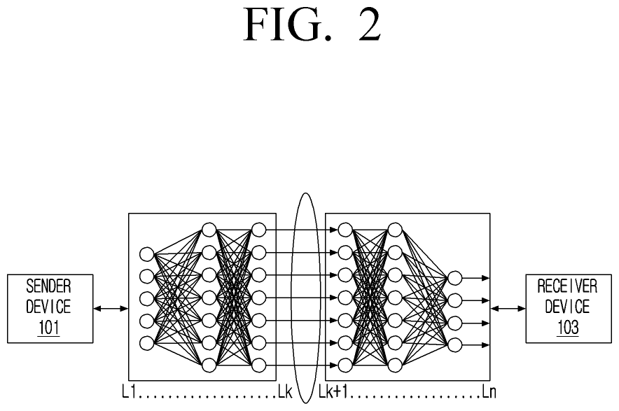

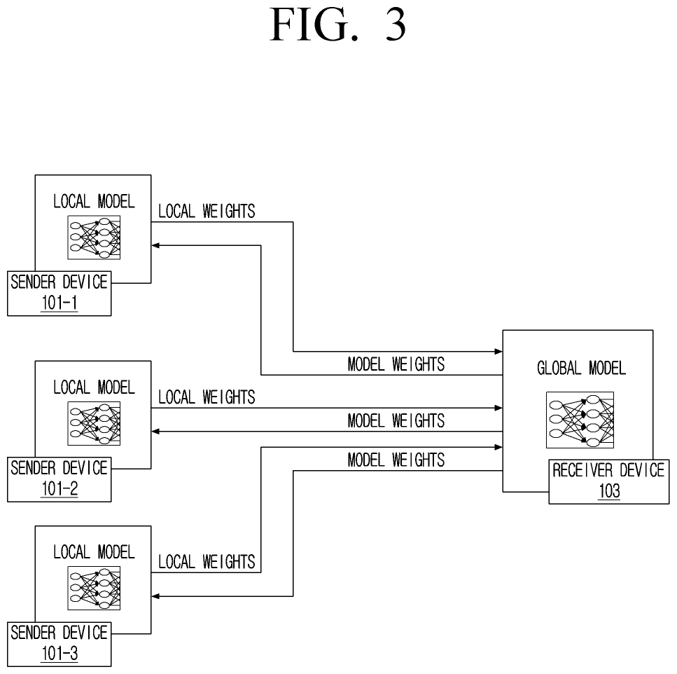

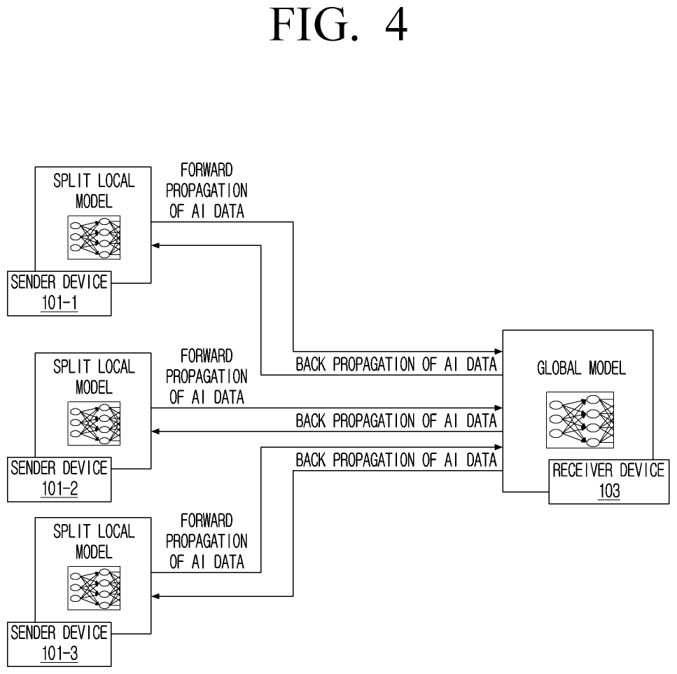

In an example embodiment, the type of AI data depends on the computing environment in which data transmission session is performed. For example, in FIG. 2 the type of AI data in the distributed AI computing environment may correspond to partial inference data which is intermediate AI data calculated by the sender device 101. The sender device 101 may perform calculation by executing for example a partial Artificial Neural Networks (ANN) model including layers L1 to Lk. After execution, an output is generated which is sent to the receiver device 103 for executing the partial ANN model including the remaining layers Lk+1 to Ln. Further, FIG. 3 shows data communication in a federation learning environment, wherein the type of AI data may correspond to data related to weights and biases calculated by a plurality of sender devices (as shown in FIG. 3 as 101-1, 101-2, and 101-3) on executing their respective local models. In an example embodiment, the local models may be AI models that use available data for training. However, these models internally separate the data into local groups and further train an AI model for each group. The receiver device 103 updates a global model stored on its end, upon receiving the weights and biases from the plurality of sender devices. In an embodiment, global models are the AI models that are configured to train a single classifier model based on the available data for training. Thereafter, the receiver device 103 may transmit the data related to the updated model to the plurality of sender devices. Similarly, FIG. 4 shows data communication in a split federated learning environment. The type of data associated with the split federated learning environment corresponds to intermediate propagation data that further includes data related to loss and gradient in the split federated learning environment.

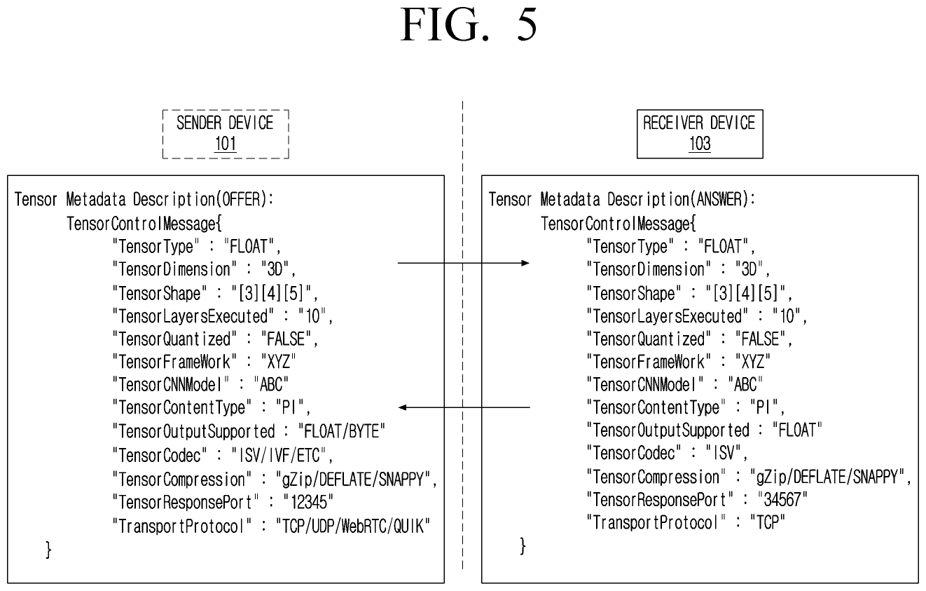

Returning to FIG. 1, upon transmission of the request, the sender device 101 receives a response from the receiver device 103 based on the request. The response indicates at least one negotiated parameter for the transmitted AI metadata description, based on capabilities associated with the receiver device 103. In an example embodiment, the at least one negotiated parameter is indicative of at least one of compatible parameters and incompatible parameters from the one or more protocol instances and the one or more predefined parameters. For example, in FIG. 5, negotiation of AI metadata description between the sender device 101 and the receiver device 103 is shown. In an example, the protocol instance such as the transport protocol for the AI data supported on the sender device 101 may be WebRTC. However, the same transport protocol may not be supported by the receiver device 103. Rather, a Transmission Control Protocol (TCP) which is a different transport protocol, may be supported on the receiver device 103. Therefore, the sender device 101 receives the TCP transport protocol as the compatible parameter for the AI data, from the receiver device 103. Similarly, as seen from FIG. 5, the AI response port changed from “12345” to “34567”, and the AI codec is changed from “ISV/IVF/ETC” to “ISV”, as the receiver may be compatible only with the ISV AI codec.

In this manner, the negotiation session is completed upon receiving the response based on the request, and a data transmission session is established between the sender device 101 and the receiver device 103. In an example embodiment, the negotiated parameters are exchanged based on predefined session protocols, which may include, but are not limited to, Session Description Protocol (SDP), Hypertext Transfer Protocol (HTTP), Transmission Control Protocol (TCP), User Datagram Protocol (UDP) headers, custom messages, and the like. Any other session protocol not mentioned herein explicitly may also be utilised for exchanging the negotiated parameters. Therefore, the transmission of AI data takes place after the AI metadata description is negotiated between the sender device 101 and the receiver device 103.

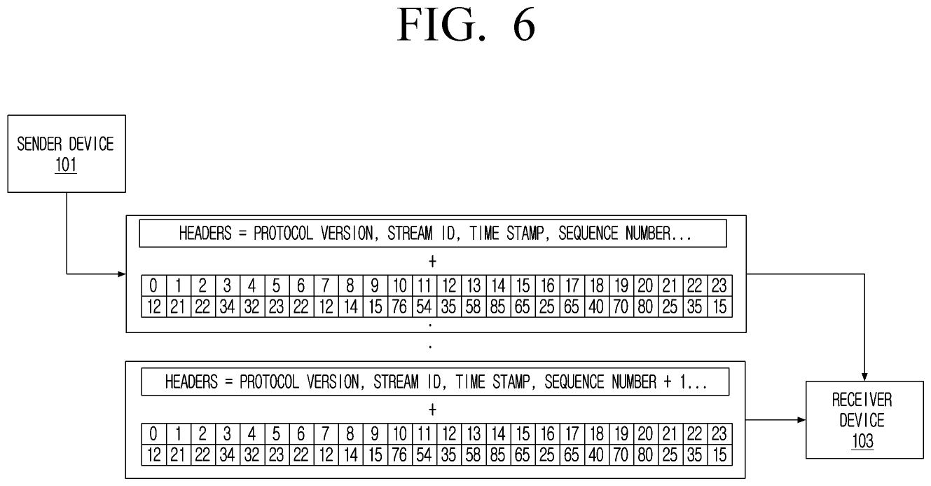

Thereafter, the sender device 101 transmits the AI data to the receiver device 103 during the data session based on the response. In an example embodiment, establishing the data session includes assigning at least one unique stream identifier for communicating the AI data. The at least one unique stream identifier is further used for sending the AI data associated with the application, to the receiver device 103. For example, FIG. 6 shows an example embodiment of transmission of AI data between a sender device and a receiver device. As shown in FIG. 6, the AI data is transmitted in payloads and headers which hold unique header parameters of the AI data such as stream identifier, sequence number, timestamp, size of AI data and AI data processor. The stream identifier facilitates in identifying how many AI data streams are currently active. Each AI data protocol instance created for an AI activity creates one AI data stream ID. Further, the sequence number of the AI data is incremented each time a chunk of the AI data, such as a first set of partial inference data, is sent to the receiver device 103. The timestamp is indicative of a time instance at which the AI data frame is sent to the receiver device 103. Further, the AI data is transmitted from the sender device 101 to the receiver device 103 in payloads associated with the headers. Furthermore, AI data processors refer, for example, to processors used for performing the AI activities on the sender device 101. The AI data processors may include but are not limited to, Control Processing Unit (CPU), Graphics Processing Unit (GPU), Neural Processing Unit (NPU), Tensor Processing Unit (TPU), and the like. Therefore, the sender device 101 uses at least one of the unique header parameters for sending the AI data associated with the application to the receiver device 103.

Returning to FIG. 1, in an embodiment, during an on-going data transmission session, the sender device 101 may re-negotiate the AI metadata description associated with changes due to predefined factors. In an example embodiment, the predefined factors may correspond to at least one of one or more variations in network conditions associated with the transmission of the AI data, and availability of the receiver device 103 and one or more computing resources which are associated with the transmission of the respective AI data. Thus, the sender device 101 generates an updated AI metadata description for the AI data that is transmitted during the on-going data session. The updated AI metadata description includes changes in the one or more predefined parameters and the one or more protocol instances negotiated previously with the receiver device 103.

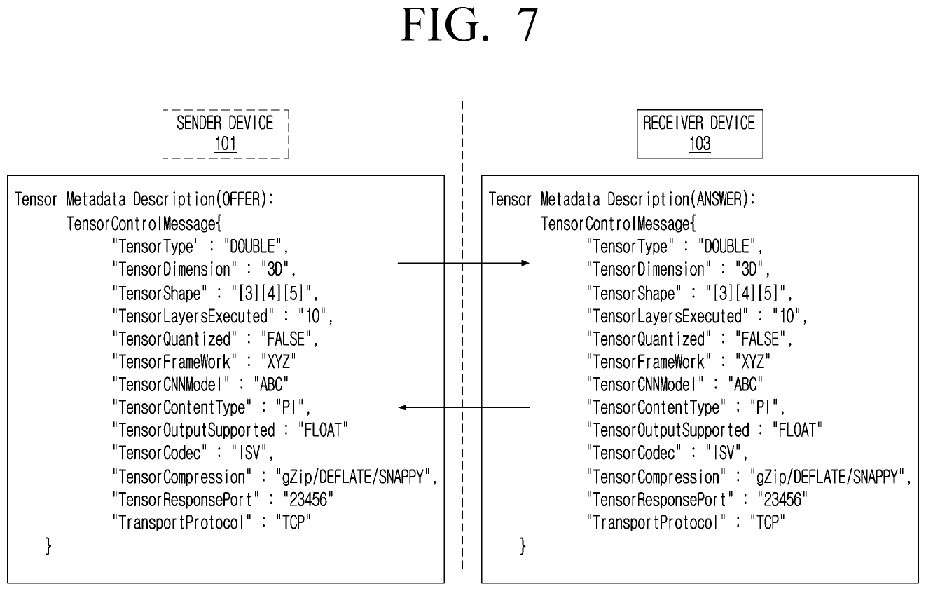

Then, the sender device 101 may transmit the updated AI metadata description to the receiver device 103. This is followed by receiving an updated response by the sender device 101 from the receiver device 103, based on the corresponding updated AI metadata description. The updated response includes at least one negotiated parameter for the updated AI metadata description. For example, FIG. 7 shows an example embodiment of re-negotiation of the previously negotiated AI metadata description. Particularly, referring to FIG. 5, on comparing the negotiated AI metadata description of FIG. 5 with FIG. 7, it is seen that tensor type changed from FLOAT to DOUBLE. Similarly, tensor codec changed from allowing all types of codec to allowing only ISV codec due to changes in the predefined factors. Therefore, in this manner, the example embodiments of the present disclosure can facilitate performing dynamic re-negotiation during an on-going data transmission session.

Returning to FIG. 1, the receiver device 103 is configured to receive the request including the AI metadata description from the sender device 101. The request is received by the receiver device 103 prior to establishing the data session for dynamically managing the communication of the AI data. As described above, the AI metadata description includes the one or more protocol instances and the one or more predefined parameters. Therefore, as mentioned in the above section, the receiver device 103 determines compatibility of each of the one or more predefined parameters and the one or more protocol instances received. In an example embodiment, the receiver device 103 may determine the compatibility by checking whether the received information is compatible with an environment associated with the receiver device 103.

Further, the receiver device 103 generates the response for the request based on the determined compatibility. The generated response includes at least one negotiated parameter for the received AI metadata description. Further, the negotiated parameters are indicative of either compatible parameters or incompatible parameters, from the one or more protocol instances and the one or more predefined parameters. In an example embodiment, the compatible parameters indicate, for example, acceptable parameters which are compatible with the environment of the receiver device 103. In contrast, when the one or more predefined parameters and the one or more protocol instances are not compatible with the environment of the receiver device 103, the receiver device 103 may generate a new set of parameters which correspond to the negotiated parameters. These negotiated parameters are compatible with the environment of the receiver device 103. Therefore, the response generated by the receiver device 103 includes negotiated parameters.

Furthermore, the receiver device 10 sends generated response to the sender device 101. Upon sending the response, the data session is established between the receiver device 103 and the sender device 101. Thereafter, the receiver device 103 receives the AI data from the sender device 101 during the data session based on the response. For illustration purpose, one sender device 101 and one receiver device 103 are shown in FIG. 1, however, in a computing environment, one or more sender devices and one or more receiver devices can perform communication of the AI metadata description and AI data.

In an example embodiment, as mentioned above, during the on-going data transmission session, the receiver device 103 may dynamically receive the updated AI metadata description for the AI data which is being transmitted from the sender device 101. The updated AI metadata description includes changes in the one or more protocol instances and the one or more predefined parameters which are previously negotiated between the receiver device 103 and the sender device 101. The receiver device 103 further determines the compatibility of the one or more predefined parameters and the one or more protocol instances which are associated with the received AI data. Thereafter, the receiver device 103 may generate and transmit the updated response for the updated AI metadata description for performing the re-negotiation. Thereafter, the receiver device 103 receives the AI data from sender device 101 during the data session based on the updated response.

In an example embodiment of the present disclosure, when the negotiated parameters are communicated between the sender device 101 and the receiver device 103, the sender device 101 may accordingly enable and disable the AI codecs. For example, when the negotiated parameter corresponds to AI codecs (encoder/decoder), then it is known that the exiting AI codec may not be giving an optimal AI data reduction or optimal transfer time. Thus, the AI codec is re-negotiated by enabling a different AI codec or dynamically disabling the existing AI codec based on the changes detected by the sender device 101.

In this manner, the communication of the AI data is managed dynamically between the sender device 101 and the receiver device 103 in various computing environments. In an example, the sender device 101 may be simultaneously associated with two applications. The AI information associated with the two applications may be transmitted to two receiver devices such as first and second receiver devices. Therefore, the sender device 101 may send the two requests including the AI metadata description associated with the respective applications, to the respective receiver devices. For instance, the first request may include the type of AI data corresponding to partial inference and the second request may include the type of AI data corresponding to weights and biases. Further, the sender device 101 may establish two data sessions with the respective receiver devices for streaming the AI data associated with the respective applications. Hence, example embodiments of the present disclosure can facilitate data negotiation sessions prior to the streaming of the AI data exchanged between the sender device 101 and one or more receiver devices, followed by providing dynamic data negotiations after the data sessions are established.

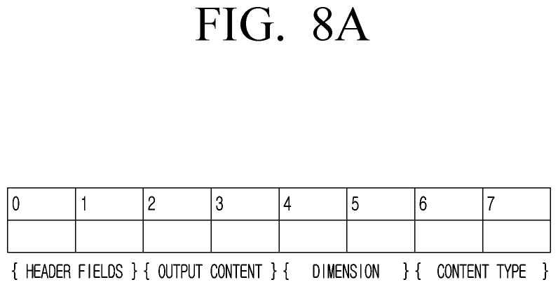

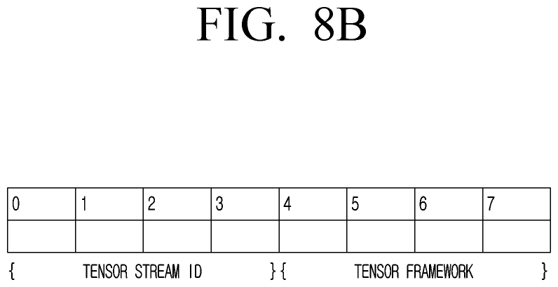

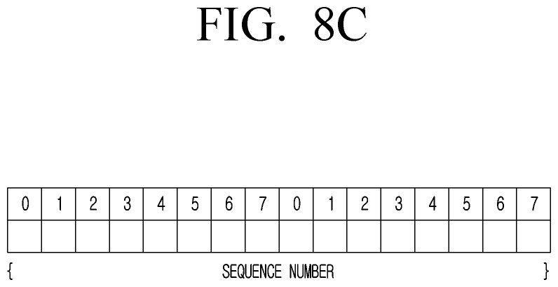

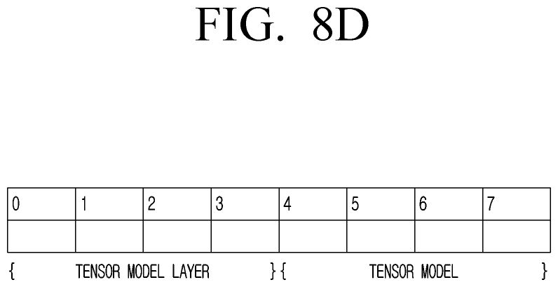

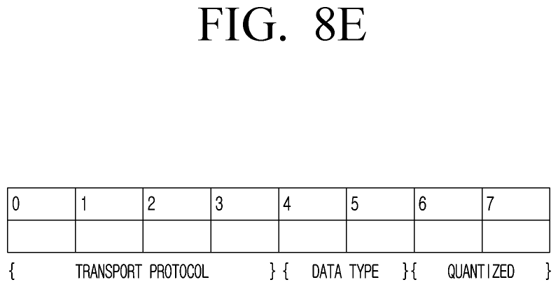

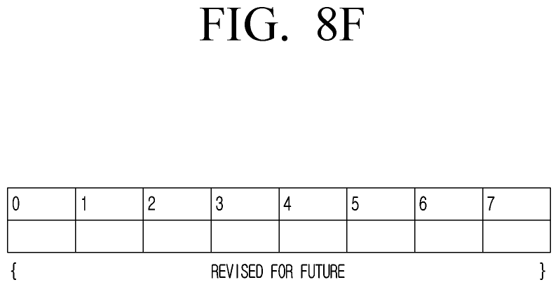

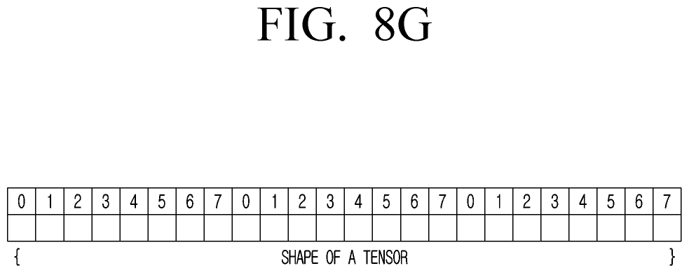

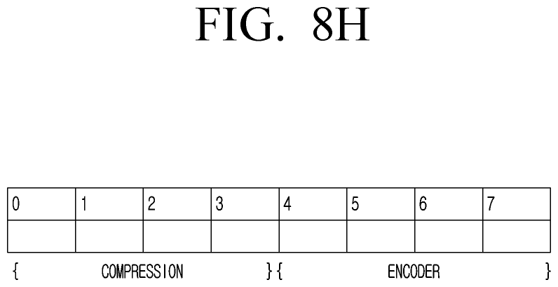

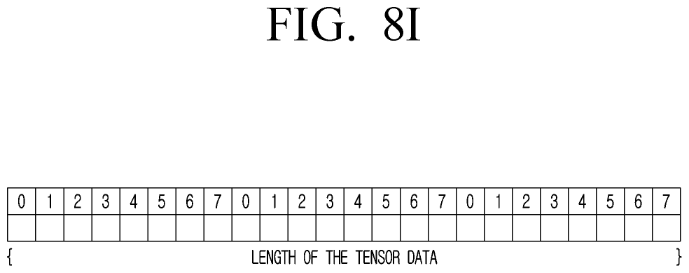

In an example embodiment of the present disclosure, the communication of the AI data is managed between the sender device 101 and the receiver device 103 by transmitting the AI metadata as a part of headers which are transmitted during the data session. The headers are required during initial setup of a data session. For example, when a bit in the header is set to “1” then it corresponds to a packet containing a header parameter and a payload. When the bit in the header is set to “0”, it corresponds to a packet containing only tensor payload. Further, in between multiple sessions, if any change is detected in the computing environment, for example, layers executed at the sender device 101 are changed, and then this field is set to “01”. Accordingly, the receiver device 103 is configured to read an updated header and prepare the computing environment according to the headers. The header further includes an output content field which corresponds to the AI data type associated with the AI data which may be received from the receiver device 103. The header further includes a dimension field which includes information relating to the dimension of the AI data, such that the receiver device 103 can convert the data to appropriate dimension. The header further includes a content type field which includes information related to the type of the AI data. Further, the headers include fields for each of the one or more protocol instances and the one or more predefined parameters, as shown in FIGS. 8A, 8B, 8C, 8D, 8E, 8F, 8G, 8H, and 8I.

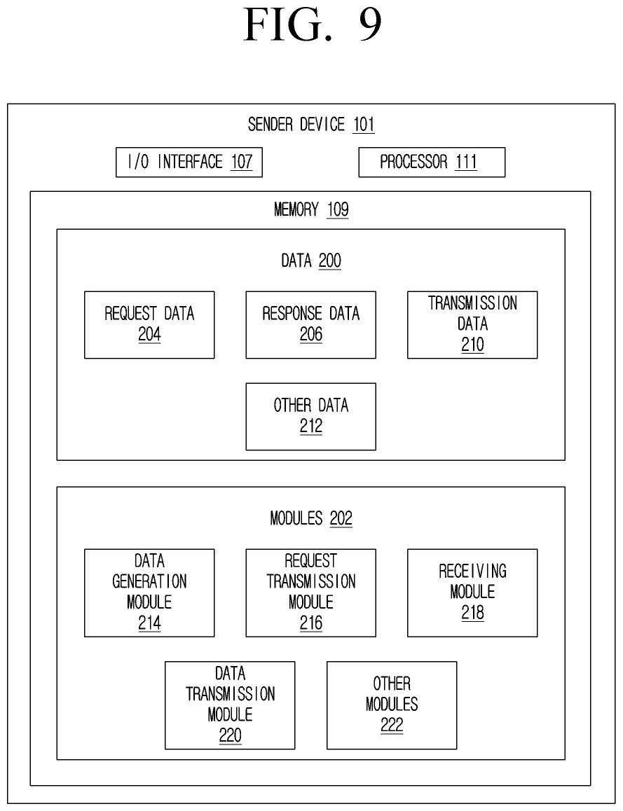

FIG. 9 shows a detailed block diagram of an example sender device in accordance with various embodiments of the present disclosure.

FIG. 9 illustrates internal architecture of the sender device 101 in accordance with various embodiments of the present disclosure. The sender device 101 may include at least one Central Processing Unit (“CPU” or “processor”) 111 and memory 109 storing instructions executable by the at least one processor 111. The processor 111 may include at least one data processor for executing program components for executing user or system-generated requests. The processor 111 according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The memory 109 is communicatively coupled to the processor 111. The sender device 101 further includes an Input/Output (I/O) interface 107. The I/O interface 107 may include input/output interface circuitry and is coupled with the processor 111 through which an input signal or/and an output signal is communicated.

In some implementations, the sender device 101 may include data 200 and modules 202. In an example embodiment, the modules 202 may include, for example, a data generation module 214, a request transmission module 216, a receiving module 218, a data transmission module 220, and other modules 222. As an example, the data 200 may be stored within the memory 109 associated with the sender device 101. In an example embodiment, the data 200 may include, for example, request data 204, response data 206, transmission data 210 and other data 212. In various embodiments, the data 200 may be stored in the memory 109 in form of various data structures.

The request data 204 may include AI metadata description. The AI metadata description further includes one or more protocol instances and one or more predefined parameters associated with the AI data. The one or more predefined parameters includes, but is not limited to, for example, AI (Tensor) dimension, AI shape, AI quantized, AI framework, AI model, AI codec, AI compression, and AI response port, and the like. The one or more protocol instances may include, but is not limited to, for example, an AI type, a content type, a response data type, a transport protocol, and a predefined range of AI model layers executed by an AI model associated with an application.

The response data 206 may include, for example, negotiated parameters including at least one compatible parameter and/or incompatible parameter. The compatible parameters may correspond, for example, to acceptable parameters which are accepted by the receiver device 103. Further, the incompatible parameters may correspond, for example, to the non-acceptable parameters which are not accepted by the receiver device 103 as they are incompatible with an environment associated with the receiver device 103.

The transmission data 208 may include, for example, the AI data to be transmitted to the one or more receiver devices during the data session. The transmission data 208 may further include unique header parameters for sending the AI data associated with the application to the receiver device 103. The unique header parameters may include, but are not limited to, for example, stream identifier, sequence number, timestamp, AI data payload, size of AI data, and AI data processor.

The other data 210 may store data, including temporary data and temporary files, generated by the one or more modules 202 for performing the various functions of the sender device 101. The one or more modules 202 may also include the other modules 222 to perform various miscellaneous functionalities of the sender device 101. The other data 212 may be stored in the memory 109. It will be appreciated that the one or more modules 202 may be represented as a single module or a combination of different modules.

The data generation module 214 is configured to, for example, generate one or more protocol instances associated with the AI data for an application executed on the sender device 101. The data generation module 214 may input data associated with each of the one or more applications and further execute an AI model associated with the sender device 101 on the input data. The data generation module 214 further generates an output once the execution of the application associated with AI data is completed. The data generation module 214 is further configured to generate the AI metadata description based on AI model information associated with the AI data. Particularly, the data generation module 214 obtains input data associated with each of the one or more applications and executes an AI model on the obtained input data. On performing the execution of the AI model, the data generation module 214 generates an output including the AI data which is associated with each of the one or more applications.

The request transmission module 216 is configured to, for example, receive the AI metadata description from the data generation module 214. The request transmission module 216 further sends the AI metadata description as a request to the receiver device 103 for establishing a session between the sender device 101 and the receiver device 103. The request transmission module 216 is further configured to perform negotiation of the AI metadata description between the sender device 101 and the receiver device 103. The AI metadata description is negotiated by the request transmission module 216 based on capabilities associated with the receiver device 103. In an example embodiment, the request transmission module 216 is configured to receive the negotiated parameters from the receiver device 103, based on predefined session protocols. The predefined session protocols may include, but are not limited to, for example, Session Description Protocol (SDP), Hypertext Transfer Protocol (HTTP), Transmission Control Protocol (TCP), User Datagram Protocol (UDP) headers, custom messages, and the like. Furthermore, the request transmission module 216 is configured to assign at least one unique header parameter for the sender device 101, in order to communicate the AI data. The unique header parameters may include, for example, stream identifier, sequence number, timestamp, AI data payload, size of AI data and AI data processor. In an example embodiment, the request transmission module 216 may negotiate the AI metadata description based on AI header parameters.

The receiving module 218 is configured to, for example, receive a response from the receiver device 103 based on the request. The response includes at least one negotiated parameter for the transmitted AI metadata description, which is negotiated by the request transmission module 216. Upon receiving the response, the receiving module 218 establishes a session between the sender device 101 and the receiver device 103.

The data transmission module 220 is configured to, for example, receive the response from the receiving module 218 and further transmit the AI data associated with the negotiated parameters of the corresponding AI metadata description, to the receiver device 103. The data transmission module 220 performs transmission of the AI data during the session established by the receiving module 218.

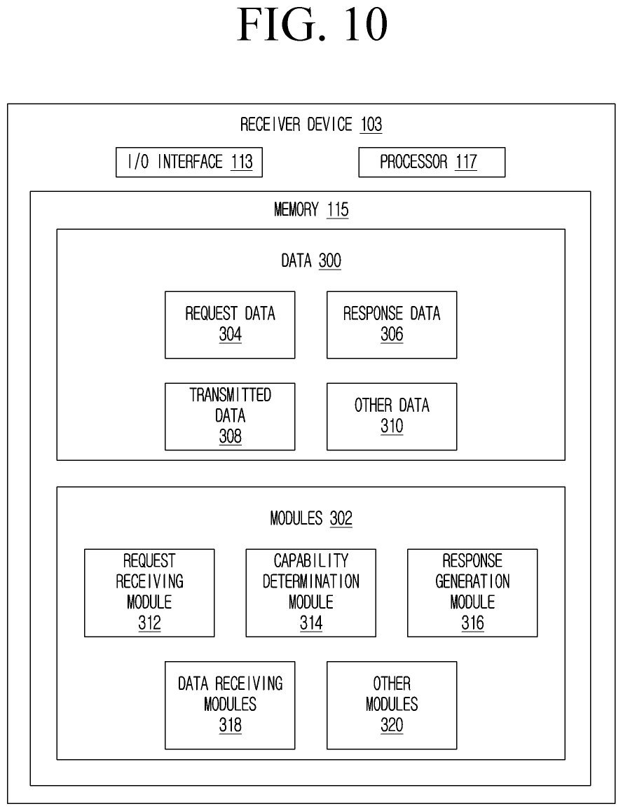

FIG. 10 shows a detailed block diagram of an example receiver device in accordance with various embodiments of the present disclosure.

FIG. 10 illustrates internal architecture of the receiver device 103 in accordance with various embodiments of the present disclosure. The receiver device 103 may include at least one Central Processing Unit (“CPU” or “processor”) 117 and memory 115 storing instructions executable by the at least one processor 117. The processor 117 may include at least one data processor for executing program components for executing user or system-generated requests. The processor 111 according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The memory 109 is communicatively coupled to the processor 117. The receiver device 103 further includes an Input/Output (I/O) interface 113. The I/O interface 113 includes, for example, I/O interface circuitry and is coupled with the processor 117 through which an input signal or/and an output signal is communicated.

In various example embodiments, the receiver device 103 may include data 300 and modules 302. In an example embodiment, the modules 302 may include, for example, a request receiving module 312, a compatibility determination module 314, a response generation module 316, data receiving modules 318 and other modules 320. As an example, the data 300 may be stored within the memory 115 associated with the receiver device 103. In an example embodiment, the data 300 may include, for example, request data 304, response data 306, transmitted data 308 and other data 310. In various embodiments, the data 300 may be stored in the memory 115 in form of various data structures.

The request data 304 may include AI metadata description. The AI metadata description further includes one or more protocol instances and one or more predefined parameters associated with the AI data. The one or more predefined parameters includes, for example, AI (Tensor) dimension, AI shape, AI quantized, AI framework, AI model, AI codec, AI compression, and AI response port and the like. The one or more protocol instances may include, for example, an AI type, a content type, a response data type, a transport protocol, and a predefined range of AI model layers executed by an AI model associated with the application.

The response data 306 may include, for example, negotiated parameters including at least one compatible parameter and/or incompatible parameter. The compatible parameters may correspond to, for example, acceptable parameters which are accepted by the receiver device 103. Further, the incompatible parameters correspond to, for example, the non-acceptable parameters which are not accepted by the receiver device 103 as they are incompatible with an environment associated with the receiver device 103.

The transmitted data 308 may include the AI data which is received from the sender device 101 during the data session. The transmitted data 308 may further include unique header parameters for sending the AI data associated with the application to the receiver device 103. The unique header parameters include, for example, stream identifier, sequence number, timestamp, AI data payload, size of AI data and AI data processor.

The other data 310 may store data, including temporary data and temporary files, generated by the one or more modules 302 for performing the various functions of the receiver device 103. The one or more modules 302 may also include the other modules 320 to perform various miscellaneous functionalities of the receiver device 103. The other data 310 may be stored in the memory 115. It will be appreciated that the one or more modules 302 may be represented as a single module or a combination of different modules.

In an example embodiment, the request receiving module 312 is configured to receive a request including the AI metadata description from the sender device 101 for establishing the session between the sender device 101 and the receiver device 103. For purposes of illustration, one sender device 101 and one receiver device 103 are shown, however, in a computing environment, one or more sender devices and one or more receiver devices can perform communication of the AI metadata description and AI data.

In an example embodiment, the compatibility determination module 314 may receive the request from the request receiving module 312 and determine compatibility of each of the one or more protocol instances and the one or more predefined parameters. The compatibility determination module 314 may determine the compatibility by checking whether the received information is compatible with environment associated with the receiver device 103. For example, as shown in FIG. 5, on initiating negotiation, the AI response port is changed from “12345” to “34567”, and the AI codec is changed from “ISV/IVF/ETC” to “ISV”. The compatibility determination module 314 may analyse predefined factors which may correspond to network conditions and availability of one or more computing resources associated with the receiver device 103. Based on the analysis, the compatibility determination module 314 may determine that due to change in at least one predefined factor, such as unavailability of the IVF AI codec, the receiver device 103 may be compatible only with the ISV AI codec. Thus, the AI codec may be considered as a negotiated parameter.

In an example embodiment, the response generation module 316 may use the compatibilities determined by the compatibility determination module 314 for generating the response to the request received by the request receiving module 312. The response generation module 316 is further configured to transmit the response to the sender device 101. The response generated may include, for example, at least one negotiated parameter for the AI metadata description received by the request receiving module 312. Further, the response generation module 316 is configured to perform negotiation of the AI metadata description between the sender device 101 and the receiver device 103. In an example embodiment, the response generation module 316 performs transmission of the negotiated parameters based on predefined session protocols.

In an example embodiment, the data receiving module 318 is configured to receive the AI data associated with the negotiated parameters of the corresponding AI metadata description, from the sender device 101. The data receiving module 318 may receive the AI data during the session established by the request receiving module 312.

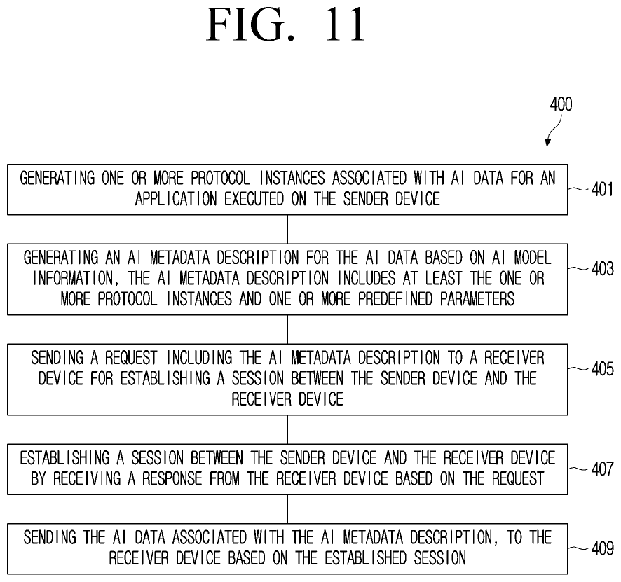

FIG. 11 shows a flowchart illustrating an example method of communicating AI data from a sender device to a receiver device in a computing environment, in accordance with various embodiments of the present disclosure.

As illustrated in FIG. 11, the method 400 includes one or more blocks illustrating an example method of communicating AI data from a sender device to a receiver device in a computing environment, in accordance with various embodiments of the present disclosure. The method 400 may be described in the general context of computer-executable instructions. Generally, computer-executable instructions can include routines, programs, objects, components, data structures, procedures, modules, and functions, which perform functions or implement abstract data types.

The order in which the method 400 is described herein is not intended to be construed as a limitation, and any number of the described method blocks can be combined in any order to implement the method 400. Additionally, individual blocks may be deleted from the methods without departing from scope of the disclosure. Furthermore, the method 400 can be implemented in any suitable hardware, software, firmware, or combination thereof.

At block 401, the method 400 may include generating, by a sender device 101, one or more protocol instances associated with AI data for an application executed on the sender device. The one or more protocol instances includes, for example, at least one of an AI type, a content type, a response data type, a transport protocol, or a predefined range of AI model layers executed by an AI model associated with the application.

At block 403, the method 400 may include generating AI metadata description for the AI data based on AI model information. The AI metadata description includes, for example, at least the one or more protocol instances and one or more predefined parameters. The one or more predefined parameters includes, for example, at least one of AI (Tensor) dimension, AI shape, AI quantized, AI framework, AI model, AI codec, AI compression, or AI response port. The method 400 may further include generating an updated AI metadata description during an on-going data session, on detecting changes in the AI data associated with the on-going data session. The updated AI metadata description is generated based on updated AI model information.

At block 405, the method 400 may include sending, by the sender device, a request including the AI metadata description to a receiver device 103 for establishing a session between the sender device 101 and the receiver device 103. The method 400 may further include sending an updated request includes the updated AI metadata description to the receiver device 103. The updated AI metadata description includes, for example, at least, one or more updated protocol instance and one or more updated predefined parameters.

At block 407, the method 400 may include establishing, by the sender device 101, a session between the sender device 101 and the receiver device 103 by receiving a response from the receiver device 103 based on the request. The method 400 may further include receiving an updated response from the receiver device 103 based on the corresponding updated AI metadata description. The updated response includes, for example, at least one negotiated parameter for the updated AI metadata description.

At block 409, the method 400 may include sending, by the sender device 101, the AI data associated with the AI metadata description, to the receiver device 103 based on the established session. The method 400 may further include sending the AI data associated with the updated AI metadata description, to the receiver device 103 based on the updated response.

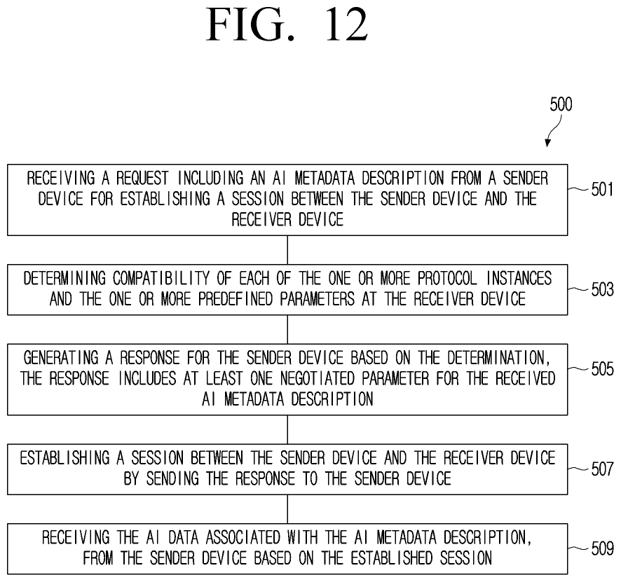

FIG. 12 shows a flowchart illustrating an example method of communicating AI data from a receiver device to a sender device in a computing environment, in accordance with various embodiments of the present disclosure.

As illustrated in FIG. 12, the method 500 includes one or more blocks illustrating an example method of communicating AI data from a receiver device 103 to a sender device 101 in a computing environment, in accordance with various embodiments of the present disclosure. The method 500 may be described in the general context of computer-executable instructions. Generally, computer-executable instructions can include routines, programs, objects, components, data structures, procedures, modules, and functions, which perform functions or implement abstract data types.

The order of operations in which the method 500 is described is not intended to be construed as a limitation, and any number of the described method blocks can be combined in any order to implement the method 500. Additionally, individual blocks may be deleted without departing from scope of the disclosure. Furthermore, the method 500 can be implemented in any suitable hardware, software, firmware, or combination thereof.

At block 501, the example method 500 may include receiving, by a receiver device 103, a request including AI metadata description from a sender device 101 for establishing a session between the sender device 101 and the receiver device 103. The AI metadata description includes at least one or more protocol instances and one or more predefined parameters. The method 500 may further include receiving an updated request during the session when the sender device 101 detects a change in at least one predefined parameter of the one or more predefined parameters and at least one protocol instance of the one or more protocol instances, while communicating the AI data. The updated request includes updated AI metadata description further including at least one or more updated protocol instance and one or more updated predefined parameters.

At block 503, the method 500 may include determining, by the receiver device 103, compatibility of each of the one or more protocol instances and the one or more predefined parameters at the receiver device 103.

At block 505, the method 500 may include generating, by the receiver device 103, a response for the sender device 101 based on the determination. The response includes at least one negotiated parameter for the received AI metadata description. The method 500 may further include generating and sending, an updated response for the sender device 101 based on the determination. The updated response includes at least one negotiated parameter for the received updated AI metadata description.

At block 507, the method 500 may include establishing, by the receiver device 103, a session between the sender device 101 and the receiver device 103 by sending the response to the sender device 101.

At block 509, the method 500 may include receiving, by the receiver device 103, the AI data associated with the AI metadata description, from the sender device 101 based on the established session. The method 500 may further include receiving the AI data associated with the updated AI metadata description, from the sender device 101 based on the updated response.

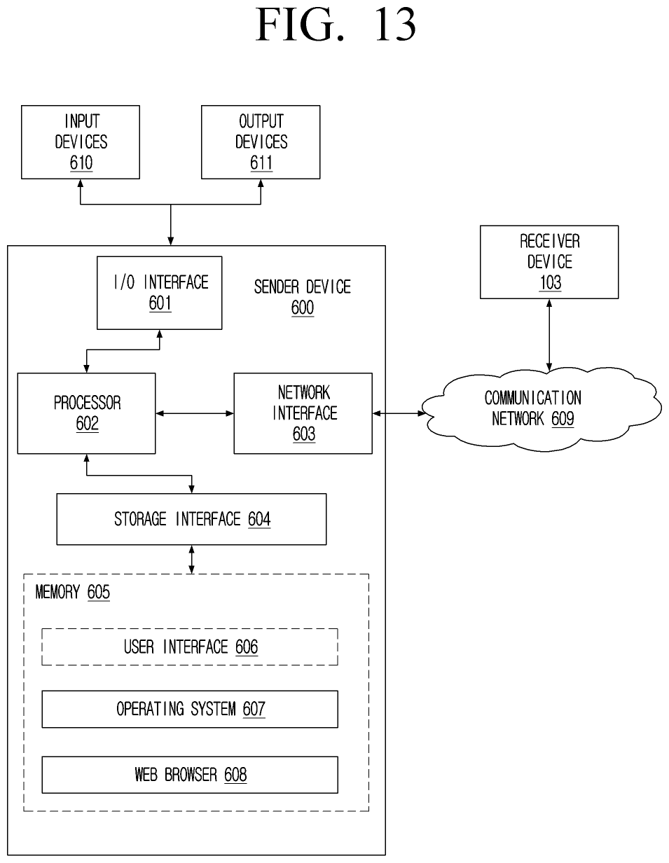

FIG. 13 is a block diagram of an example system for implementing various embodiments consistent with the present disclosure.

FIG. 13 illustrates a block diagram of an example computing system 600 for implementing embodiments consistent with the present disclosure. In various embodiments, the computing system 600 can be a sender device 101 that includes a processor (referred as a processor 602 in FIG. 13) that is used for communicating AI data to a receiver device in a computing environment. In an embodiment, the computing system 600 can be a receiver device 103 that is used for communicating AI data to the sender device 101 in the computing environment. The processor 602 may include at least one data processor for executing program components for executing user or system-generated business processes. The processor 602 may include specialized processing units such as integrated system (bus) controllers, memory management control units, floating point units, graphics processing units, digital signal processing units, etc. The processor 602 according to an embodiment of the disclosure may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The processor 602 may be disposed in communication with input devices 610 and output devices 611 via I/O interface 601. The I/O interface 601 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc.

Using the I/O interface 601, computing system 600 may communicate with input devices 610 and output devices 611.

In various embodiments, the processor 602 may be disposed in communication with a communication network 609 via a network interface 603. The network interface 603 may communicate with the communication network 609. The network interface 603 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. In an embodiment, using the network interface 603 and the communication network 609, the computing system 600 may communicate with the receiver device 103. In an embodiment, using the network interface 603 and the communication network 609, the computing system 600 may communicate with the sender device 101.

The communication network 609 can be implemented as one of the different types of networks, such as intranet or Local Area Network (LAN) and such, within the organization. The communication network 609 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other.

Further, the communication network 609 may include a variety of network devices, including routers, bridges, servers, computing devices, storage devices, etc. In various embodiments, the processor 602 may be disposed in communication with a memory 605 (e.g., RAM, ROM, etc. not shown in FIG. 13) via a storage interface 604. The storage interface 604 may connect to memory 605 including, without limitation, memory drives, removable disc drives, etc., employing connection protocols such as Serial Advanced Technology Attachment (SATA), Integrated Drive Electronics (IDE), IEEE-1394, Universal Serial Bus (USB), fibre channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 605 may store a collection of program or database components, including, without limitation, a user interface 606, an operating system 607, a web browser 608, etc. In various embodiments, the computing system 600 may store user/application data, such as the data, variables, records, etc. as described in this disclosure. Such databases may be implemented as fault-tolerant, relational, scalable, secure databases such as Oracle or Sybase.

Operating system 607 may facilitate resource management and operation of computing system 600. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2″, MICROSOFT® WINDOWS® (XP®, VISTA®/7/8, 10 etc.), APPLE® IOS®, GOOGLE™ ANDROID™, BLACKBERRY® OS, or the like. User interface 606 may facilitate display, execution, interaction, manipulation, or operation of program components through textual or graphical facilities. For example, user interfaces may provide computer interaction interface elements on a display system operatively connected to computing system 600, such as cursors, icons, check boxes, menus, scrollers, windows, widgets, etc. Graphical User Interfaces (GUIs) may be employed, including, without limitation, Apple® Macintosh® operating systems' Aqua®, IBM® OS/2®, Microsoft® Windows® (e.g., Acro, Metro, etc.), web interface libraries (e.g., ActiveX®, Java®, Javascript®, AJAX, HTML, Adobe® Flash®, etc.), or the like.

The computing system 600 may implement web browser 608. Web browser 608 may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using Secure Hypertext Transport Protocol (HTTPS), Secure Sockets Layer (SSL), Transport Layer Security (TLS), etc. Web browsers 608 may utilize facilities such as AJAX, DHTML, ADOBE® FLASH®, JAVASCRIPT®, JAVA®, Application Programming Interfaces (APIs), etc. The computing system 600 may implement a mail server stored program component. The mail server may be an Internet mail server such as Microsoft Exchange, or the like. The mail server may utilize facilities such as ASP, ACTIVEX®, ANSI® C++/C#, MICROSOFT®,. NET, CGI SCRIPTS, JAVA®, JAVASCRIPT®, PERL®, PHP, PYTHON®, WEBOBJECTS®, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In various embodiments, the computing system 600 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, etc.

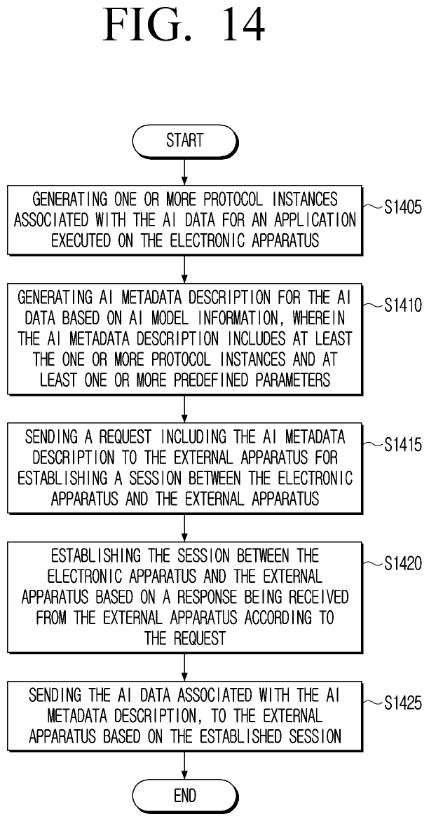

FIG. 14 is a flowchart for implementing embodiments consistent with the present disclosure.

In various example embodiments, a method of communicating AI (Artificial Intelligence) data from an electronic apparatus to an external electronic apparatus may include generating one or more protocol instances associated with the AI data for an application executed on the electronic apparatus (S1405), generating AI metadata description for the AI data based on AI model information, wherein the AI metadata description includes at least the one or more protocol instances and at least one or more predefined parameters (S1410), sending a request including the AI metadata description to the external electronic apparatus for establishing a session between the electronic apparatus and the electronic external apparatus (S1415), establishing the session between the electronic apparatus and the external electronic apparatus based on a response being received from the external electronic apparatus according to the request (S1420), and sending the AI data associated with the AI metadata description, to the external electronic apparatus based on the established session (S1425).

The electronic apparatus may be referred to, for example, as a sender device or a first electronic apparatus.

The external electronic apparatus may be referred to, for example, as a receiver device or a second electronic apparatus.

The one or more protocol instances may be referred to, for example, as protocol information, pre-determined information, or AI information related to an AI computing operation.

The application may be referred to, for example, as a pre-determined application or an application using AI algorithms.

The AI metadata description may be, referred to, for example, as AI metadata, metadata, AI description or description information.

In an example embodiment, the AI data may include information related to the AI model. The AI data may include at least one of information input to the AI model, information used in the computational process of the AI model, or information output from the AI model.

The one or more predefined parameters may be referred to, for example, as parameters related to the AI model.

The request may be referred to, for example, as a request signal or a signal for requesting the AI metadata description.

In an example embodiment, the one or more protocol instances may include at least one of an AI type, a content type, a response data type, a transport protocol, or a predefined range of AI model layers executed by an AI model associated with the application.

In an example embodiment, the one or more predefined parameters may include at least one of AI (Tensor) dimension, AI shape, AI quantized, AI framework, AI model, AI codec, AI compression, or AI response port.

In an example embodiment, the method may include dynamically generating an updated AI metadata description during an on-going data session, on detecting changes in the AI data associated with the on-going data session, wherein the updated AI metadata description is generated based on updated AI model information, sending an updated request including the updated AI metadata description to the external electronic apparatus, wherein the updated AI metadata description includes at least one or more updated protocol instance and at least one or more updated predefined parameters, receiving an updated response from the external electronic apparatus based on the corresponding updated AI metadata description, wherein the updated response includes at least one negotiated parameter for the updated AI metadata description, and sending the AI data associated with the updated AI metadata description, to the external electronic apparatus based on the updated response.

In an example embodiment, a change may be detected by the electronic apparatus based on at least one of one or more variations in network conditions associated with the electronic apparatus and availability of the external apparatus or one or more computing resources associated with the AI data.

In an example embodiment, the response may include at least one negotiated parameter for the AI metadata description, based on capabilities associated with the external apparatus.

In an example embodiment, the at least one negotiated parameter may be indicative of compatible parameters and/or incompatible parameters, from the one or more protocol instances and the one or more predefined parameters.

In an example embodiment, the at least one negotiated parameter may be transmitted based on predefined session protocols.

In an example embodiment, the establishing of the session may include assigning at least one unique header parameter including stream identifier, sequence number, timestamp, AI data payload, size of AI data and AI data processor, for the electronic apparatus to communicate the AI data.

In an example embodiment, the at least one unique header parameter may be used for sending the AI data associated with the application, to the external electronic apparatus.

In an example embodiment, the AI metadata description and the AI data may be negotiated and transmitted, respectively, between the electronic apparatus and the external electronic apparatus using AI header parameters.

In an example embodiment, a method of communicating AI data from an external electronic apparatus to an electronic apparatus in a computing environment may include receiving, by the external electronic apparatus, a request including AI metadata description from the electronic apparatus for establishing a session between the electronic apparatus and the external electronic apparatus, wherein the AI metadata description may include at least one or more protocol instances and one or more predefined parameters, determining, by the external electronic apparatus, compatibility of each of the one or more protocol instances and the one or more predefined parameters at the external electronic apparatus, generating, by the external electronic apparatus, a response for the electronic apparatus based on the determination, wherein the response may include at least one negotiated parameter for the received AI metadata description, and establishing, by the external electronic apparatus, a session between the electronic apparatus and the external electronic apparatus on sending the response to the electronic apparatus, and receiving, by the external electronic apparatus, the AI data associated with the AI metadata description, from the electronic apparatus based on the established session.

In an embodiment, the one or more protocol instances may include, for example, at least one of an AI type, a content type, a response data type, a transport protocol, or a predefined range of AI model layers executed by an AI model associated with the application.

In an embodiment, the one or more predefined parameters may include at least one of AI (Tensor) dimension, AI shape, AI quantized, AI framework, AI model, AI codec, AI compression, or AI response port.

In an embodiment, the method may include receiving an updated request during the session when the electronic apparatus detects a change in at least one predefined parameter of the one or more predefined parameters and at least one protocol instance of the one or more protocol instances, while communicating the AI data, wherein the updated request may include updated AI metadata description further including at least one or more updated protocol instance and one or more updated predefined parameters, determining compatibility of each of the one or more protocol instances and the one or more predefined parameters at the external electronic apparatus, generating and sending, an updated response for the electronic apparatus based on the determination, wherein the updated response may include at least one negotiated parameter for the received updated AI metadata description, and receiving the AI data associated with the updated AI metadata description, from the electronic apparatus based on the updated response.

In an embodiment, the at least one negotiated parameter may be indicative of, for example, at least compatible parameters and/or incompatible parameters, from the one or more protocol instances and the one or more predefined parameters.

In an embodiment, the at least one negotiated parameter may be transmitted based on predefined session protocols.

In an embodiment, the establishing of the session may include assigning at least one unique header parameter including, for example, stream identifier, sequence number, timestamp, AI data payload, size of AI data or AI data processor, for the electronic apparatus to communicate the AI data.

In an embodiment, the at least one unique header parameter may be used for sending the AI data associated with the application, to the external electronic apparatus.

In an embodiment, the AI metadata description and the AI data may be negotiated and transmitted, respectively, between the electronic apparatus and the external electronic apparatus using AI header parameters.

In an example embodiment, an electronic apparatus for communicating AI (Artificial Intelligence) data from an electronic apparatus to an external electronic apparatus may include at least one processor, and a memory communicatively coupled to the at least one processor, wherein the memory stores instructions, which, on execution by the at least one processor, causes the electronic apparatus to generate one or more protocol instances associated with the AI data for an application executed on the electronic apparatus, generate AI metadata description for the AI data based on AI model information, wherein the AI metadata description may include at least the one or more protocol instances and at least one or more predefined parameters, send a request including the AI metadata description to the external electronic apparatus for establishing a session between the electronic apparatus and the external electronic apparatus, establish the session between the electronic apparatus and the external electronic apparatus based on a response being received from the external electronic apparatus according to the request, and send the AI data associated with the AI metadata description, to the external electronic apparatus based on the established session.

In an embodiment, the one or more protocol instances may include, for example, at least one of an AI type, a content type, a response data type, a transport protocol, or a predefined range of AI model layers executed by an AI model associated with the application.

In an embodiment, the one or more predefined parameters may include, for example, at least one of AI (Tensor) dimension, AI shape, AI quantized, AI framework, AI model, AI codec, AI compression, or AI response port.

In an embodiment, the instructions, on execution, may cause the electronic apparatus to dynamically generate an updated AI metadata description during an on-going data session, on detecting changes in the AI data associated with the on-going data session, wherein the updated AI metadata description may be generated based on updated AI model information, send an updated request including the updated AI metadata description to the external electronic apparatus, wherein the updated AI metadata description may include at least one or more updated protocol instance and at least one or more updated predefined parameters, receive an updated response from the external electronic apparatus based on the corresponding updated AI metadata description, wherein the updated response may include at least one negotiated parameter for the updated AI metadata description, and send the AI data associated with the updated AI metadata description, to the external electronic apparatus based on the updated response.

In an embodiment, the instructions, on execution, may cause the electronic apparatus to detect the change based on at least one of one or more variations in network conditions associated with the electronic apparatus and availability of the external apparatus or one or more computing resources associated with the AI data.

In an embodiment, the response may include at least one negotiated parameter for the transmitted AI metadata description, based on capabilities associated with the external electronic apparatus.

In an embodiment, the at least one negotiated parameter may be indicative of, for example, at least compatible parameters and/or incompatible parameters, from the one or more protocol instances and the one or more predefined parameters.

In an embodiment, the instructions, on execution, may cause the electronic apparatus to transmit the negotiated parameter based on predefined session protocols.

In an embodiment, the instructions, on execution, may cause the electronic apparatus to establish the session by assigning, for example, at least one unique header parameter including stream identifier, sequence number, timestamp, AI data payload, size of AI data and AI data processor, for the electronic apparatus to communicate the AI data.

In an embodiment, the instructions, on execution, may cause the electronic apparatus to use the at least one unique header parameter for sending the AI data associated with the application, to the external electronic apparatus.

In an embodiment, the instructions, on execution, may cause the electronic apparatus to negotiate the AI metadata description and transmit the AI data, between the electronic apparatus and the external electronic apparatus using AI header parameters.

In an example embodiment, an external electronic apparatus for communicating AI data from the external electronic apparatus to an electronic apparatus in a computing environment may include at least one processor, and a memory communicatively coupled to the at least one processor, wherein the memory stores instructions which, on execution by the at least one processor, cause the external electronic apparatus to receive a request including AI metadata description from the electronic apparatus for establishing a session between the electronic apparatus and the external electronic apparatus, wherein the AI metadata description may include at least one or more protocol instances and one or more predefined parameters, determine compatibility of each of the one or more protocol instances and the one or more predefined parameters at the external electronic apparatus, generate a response for the electronic apparatus based on the determination, wherein the response may include at least one negotiated parameter for the received AI metadata description, establish a session between the electronic apparatus and the external electronic apparatus on sending the response to the electronic apparatus, and receive the AI data associated with the AI metadata description, from the electronic apparatus based on the established session.

In an embodiment, the one or more protocol instances may include, for example, at least one of an AI type, a content type, a response data type, a transport protocol, or a predefined range of AI model layers executed by an AI model associated with the application.

In an embodiment, the one or more predefined parameters may include at least one of AI (Tensor) dimension, AI shape, AI quantized, AI framework, AI model, AI codec, AI compression, or AI response port.

In an embodiment, the instructions, on execution, may cause the external electronic apparatus to receive an updated request during the session when the electronic apparatus detects a change in at least one predefined parameter of the one or more predefined parameters and at least one protocol instance of the one or more protocol instances, while communicating the AI data, wherein the updated request may include updated AI metadata description further including at least, one or more updated protocol instance and one or more updated predefined parameters, determine compatibility of each of the one or more protocol instances and the one or more predefined parameters at the external electronic apparatus, generate and send an updated response for the electronic apparatus based on the determination, wherein the updated response may include at least one negotiated parameter for the received updated AI metadata description, and receive the AI data associated with the updated AI metadata description, from the electronic apparatus based on the updated response.

In an embodiment, the at least one negotiated parameter may be indicative of, for example, at least compatible parameters and/or incompatible parameters, from the one or more protocol instances and the one or more predefined parameters.

In an embodiment, the instructions, on execution, may cause the external electronic apparatus to transmit the negotiated parameter based on predefined session protocols.

In an embodiment, the instructions, on execution, may cause the external electronic apparatus to establish the session by assigning, for example, at least one unique header parameter including stream identifier, sequence number, timestamp, AI data payload, size of AI data and AI data processor, for the electronic apparatus to communicate the AI data.

In an embodiment, the instructions, on execution, may cause the external electronic apparatus to use the at least one unique header parameter for sending the AI data associated with the application, to the electronic apparatus.

In an embodiment, the instructions, on execution, may cause the external electronic apparatus to negotiate the AI metadata description and transmit the AI data, between the electronic apparatus and the external electronic apparatus using AI header parameters.

Furthermore, one or more computer-readable storage media may be utilized in implementing embodiments consistent with the disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the example embodiments described herein. The term “non-transitory computer-readable medium” should be understood to include tangible items. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

The terms “an embodiment”, “embodiment”, “embodiments”, “the embodiment”, “the embodiments”, “one or more embodiments”, “various embodiments”, and “one embodiment” refer to, for example, “one or more (up to and including all) embodiments” unless expressly specified otherwise.

The terms “including”, “comprising”, “having” and variations thereof refer to, for example, “including but not limited to”, unless expressly specified otherwise.

The enumerated listing of items does not imply that any or all of the items are mutually exclusive, unless expressly specified otherwise. The terms “a”, “an” and “the” refer to, for example, “one or more”, unless expressly specified otherwise.

A description of an embodiment with several components in communication with each other does not imply that all such components are required. On the contrary a variety of optional components are described to illustrate the wide variety of possible embodiments of the disclosure.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

The present disclosure provides example methods and devices for communicating AI data from an (sender) electronic apparatus 101 to an (receiver) external apparatus 103 in a computing environment. The present disclosure provides example methods for AI data streaming which saves numerous unwanted and out-of-domain activities such as, connection management, dynamic negotiation, dynamic encoding support, and the like. Further, the present disclosure can, for example, improve inference latency by negotiating advanced AI codecs during negotiation, which reduces redundant AI data being transferred over a network. The present disclosure can, for example, facilitate unified communication of AI data irrespective of vendor solutions. The example methods disclosed in the present disclosure are platform agnostic. For example, device-1 may operate using Android and device-2 operate using Linux. Further, various embodiments of the present disclosure can facilitate easy maintenance of multiple streams happening in a device by creating an instance and referring it by applications.

The illustrated operations of FIGS. 11 and 12, for example, show certain operations occurring in a certain order. In various embodiments, certain operations may be performed in a different order, may be modified, or may be removed. Moreover, operations may be added to the above-described logic and still conform to the described embodiments. Further, operations described herein may occur sequentially or certain operations may be processed in parallel. Still further, operations may be performed by a single processing unit or by distributed processing units.

Finally, the language used in the specification has been principally selected for readability and instructional purposes, and it may not have been selected to delineate or circumscribe the disclosed subject matter. It is therefore intended that the scope of the disclosure be limited not by this detailed description, but rather by any claims that issue on an application based here on. Accordingly, the various embodiments of the disclosure are intended to be illustrative, but not limiting, of the scope of the disclosure, which is set forth in the following claims.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method of communicating AI (Artificial Intelligence) data from an electronic apparatus to an external electronic apparatus, the method comprising:
generating one or more protocol instances associated with the AI data for an application executed on the electronic apparatus;
generating AI metadata description for the AI data based on AI model information, wherein the AI metadata description comprises at least the one or more protocol instances and at least one or more predefined parameters;
sending a request comprising the AI metadata description to the external electronic apparatus for establishing a session between the electronic apparatus and the external electronic apparatus;
establishing the session between the electronic apparatus and the external electronic apparatus based on a response being received from the external electronic apparatus according to the request; and
sending the AI data associated with the AI metadata description, to the external electronic apparatus based on the established session.

2. The method as claimed in claim 1, wherein the one or more protocol instances comprises at least one of an AI type, a content type, a response data type, a transport protocol, or a predefined range of AI model layers executed by an AI model associated with the application.

3. The method as claimed in claim 1, wherein the one or more predefined parameters comprise at least one of AI (Tensor) dimension, AI shape, AI quantized, AI framework, AI model, AI codec, AI compression, or AI response port.

4. The method as claimed in claim 1 further comprising:
dynamically generating an updated AI metadata description during an on-going data session, on detecting changes in the AI data associated with the on-going data session, wherein the updated AI metadata description is generated based on updated AI model information;
sending an updated request comprising the updated AI metadata description to the external electronic apparatus, wherein the updated AI metadata description comprises at least one or more updated protocol instance and at least one or more updated predefined parameters;
receiving an updated response from the external electronic apparatus based on the corresponding updated AI metadata description, wherein the updated response comprises at least one negotiated parameter for the updated AI metadata description; and
sending the AI data associated with the updated AI metadata description, to the external electronic apparatus based on the updated response.

5. The method as claimed in claim 4, wherein the change is detected by the electronic apparatus based on at least one of one or more variations in network conditions associated with the electronic apparatus and availability of the external electronic apparatus or one or more computing resources associated with the AI data.

6. The method as claimed in claim 1, wherein the response comprises at least one negotiated parameter for the AI metadata description, based on capabilities associated with the external electronic apparatus.

7. The method as claimed in claim 6, wherein the at least one negotiated parameter is indicative of at least one compatible parameter or incompatible parameter, from the one or more protocol instances and the one or more predefined parameters.

8. The method as claimed in claim 7, wherein the at least one negotiated parameter is transmitted based on predefined session protocols.

9. The method as claimed in claim 1, wherein establishing the session comprises assigning at least one unique header parameter comprising stream identifier, sequence number, timestamp, AI data payload, size of AI data and AI data processor, for the electronic apparatus to communicate the AI data.

10. The method as claimed in claim 9, wherein the at least one unique header parameter is used for sending the AI data associated with the application, to the external electronic apparatus.

11. The method as claimed in claim 1, wherein the AI metadata description and the AI data is negotiated and transmitted, respectively, between the electronic apparatus and the external electronic apparatus using AI header parameters.

12. An electronic apparatus for communicating AI (Artificial Intelligence) data from an electronic apparatus to an external electronic apparatus, the electronic apparatus comprising:
at least one processor; and
a memory communicatively coupled to the at least processor, wherein the memory stores instructions, which, on execution by the at least one processor, cause the electronic apparatus to:
generate one or more protocol instances associated with the AI data for an application executed on the electronic apparatus;
generate AI metadata description for the AI data based on AI model information, wherein the AI metadata description comprises at least the one or more protocol instances and at least one or more predefined parameters;
send a request comprising the AI metadata description to the external electronic apparatus for establishing a session between the electronic apparatus and the external electronic apparatus;
establish the session between the electronic apparatus and the external electronic apparatus based on a response being received from the external electronic apparatus according to the request; and
send the AI data associated with the AI metadata description, to the external electronic apparatus based on the established session.

13. The electronic apparatus as claimed in claim 12, wherein the one or more protocol instances comprises at least one of an AI type, a content type, a response data type, a transport protocol, or a predefined range of AI model layers executed by an AI model associated with the application.

14. The electronic apparatus as claimed in claim 12, wherein the one or more predefined parameters comprise at least one of AI (Tensor) dimension, AI shape, AI quantized, AI framework, AI model, AI codec, AI compression, or AI response port.

15. The electronic apparatus as claimed in claim 12, wherein the instructions, when executed, further cause the electronic apparatus to:
dynamically generate an updated AI metadata description during an on-going data session, on detecting changes in the AI data associated with the on-going data session, wherein the updated AI metadata description is generated based on updated AI model information;
send an updated request comprising the updated AI metadata description to the external electronic apparatus, wherein the updated AI metadata description comprises at least one or more updated protocol instance and at least one or more updated predefined parameters;
receive an updated response from the external electronic apparatus based on the corresponding updated AI metadata description, wherein the updated response comprises at least one negotiated parameter for the updated AI metadata description; and
send the AI data associated with the updated AI metadata description, to the external electronic apparatus based on the updated response.
